(19) United States
(12) Patent Application Publication
(10) Pub. No.: US 2015/0239139 A1
(43) Pub. Date: Aug. 27, 2015

(54) DEVICE FOR MUTUALLY POSITIONING TOOLS IN A CUTTING MACHINE FOR VEGETABLES

(71) Applicant: AB HALLDE MASKINER, Kista (SE)

(72) Inventors: Henrik Artursson, Bromma (SE); Thomas Nyman, Sollentuna (SE)

(73) Assignee: AB HALLDE MASKINER, KISTA (SE)

(21) Appl. No.: 14/408,782

(22) PCT Filed: Jun. 17, 2013
(86) PCT No.: PCT/SE2013/050706

§ 371 Date: Dec. 17, 2014

(30) Foreign Application Priority Data
Jun. 21, 2012 (SE) 1250670-5

(51) Int. Cl. B26D 1/29; B26D 3/22

(52) U.S. Cl. CPC B26D 1/29; B26D 3/22

(57) ABSTRACT

Device for mutually positioning tools in a cutting machine for vegetables, which cutting machine includes a machine housing, wherein in the upper part of the machine housing cutting tools are arranged to be mounted around an axis which is driven by a motor arranged in the machine housing, wherein the upper part of the machine housing is shaped as a trough, running along the periphery of the cutting tool, which trough has a bottom out from which the axis protrudes upwards and which trough is arranged to collect cut vegetables and which trough is provided with a radially directed output channel for cut vegetables. Two or more cooperating tool parts are provided, each tool part being supported directly or indirectly by one of two or several steps, arranged at a distance from each other and formed on one and the same machine element.

The present invention relates to a device for mutually positioning tools in a cutting machine for vegetables.

A common type of cutting machine for cutting vegetables or root crops comprises a machine housing, wherein, in the upper part of the machine housing, there is one or several tools mounted around an axis which is driven by a motor arranged in the machine housing. The tools comprise different types of cutting discs. The upper part of the machine housing is designed as a circular trough, or the corresponding, running along the periphery of the cutting disc. The trough has a bottom out of which the said axis protrudes upwards. The through is arranged to collect cut vegetables. The trough is provided with a radially directed output channel for cut vegetables.

In order to dice vegetables or root crops, a dicing grid with a central hole is used, which central hole is placed around the said axis. A cutting disc is placed on said axis, above the dicing grid. The cutting disc is arranged to cut off slices of the vegetable in question and to press the slices down into and through the dicing grid. During operation, the dicing grid is still while the cutting disc rotates.

Known cutting machines of this type have a machine housing which is made from die-cast aluminum. In order to support and position the dicing grid, there is a protrusion in the circular wall of the trough, against which the peripheral part of the dicing grid is arranged to rest. The cutting disc is positioned by it being supported on the upper end of said axis. In order to achieve a good result, the distance between the dicing grid and the part of the cutting disc which is closest to the dicing grid should be 0.1-0.4 millimeters.

When the distance is too large, the vegetable will be crushed.

There is a desire to make the machine housing in stainless sheet metal with a thickness of about 1-2 millimeters. It is difficult to form stainless sheet metal so that for instance double-curved surface are achieved. This leads to different parts of the machine housing being assembled from plane and bent pieces of sheet metal, which are joined together by among other techniques welding. When pieces of stainless sheet metal are welded one to the other, thermal tensions arise in the pieces, resulting in the pieces tending to deform. This, in turn, results in that it has proven very difficult to achieve the precision regarding the measurements of the machine housing which is common for a die-cast machine housing. In particular, it has turned out that it is very difficult to make a step in the trough, as described above, for supporting a dicing grid so that this has the correct distance to the cutting disc. In the corresponding way, it is very difficult to make the machine housing so that other tools can be supported by the machine housing with sufficient precision in relation to for instance a cutting disc.

The present invention solves this problem and makes it possible for the machine housing to be made from stainless sheet metal with somewhat less precision regarding the measurements of the machine housing.

Hence, the present invention relates to a device for mutually positioning tools in a cutting machine for vegetables, which cutting machine comprises a machine housing, wherein in the upper part of the machine housing cutting tools are arranged to be mounted around an axis which is driven by a motor arranged in the machine housing, wherein the upper part of the machine housing is shaped as a trough, running along the periphery of the cutting tool, which trough has a bottom out from which the said axis protrudes upwards and which trough is arranged to collect cut vegetables and which trough is provided with a radially directed output channel for cut vegetables, and is characterised in that two or more cooperating tool parts are provided, in that each tool part is supported directly or indirectly by one of two or several steps, arranged at a distance from each other and formed on one and the same machine element.

Below, the present invention is described in closer detail, partly in connection to embodiments shown in the appended drawings, in which

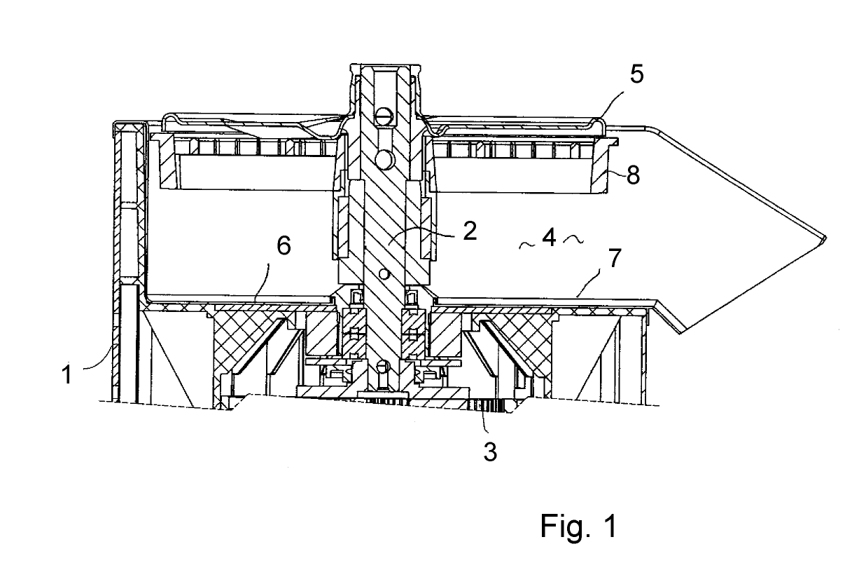

FIG. 1 shows a cross-section from the side of the upper part of a cutting machine for vegetables

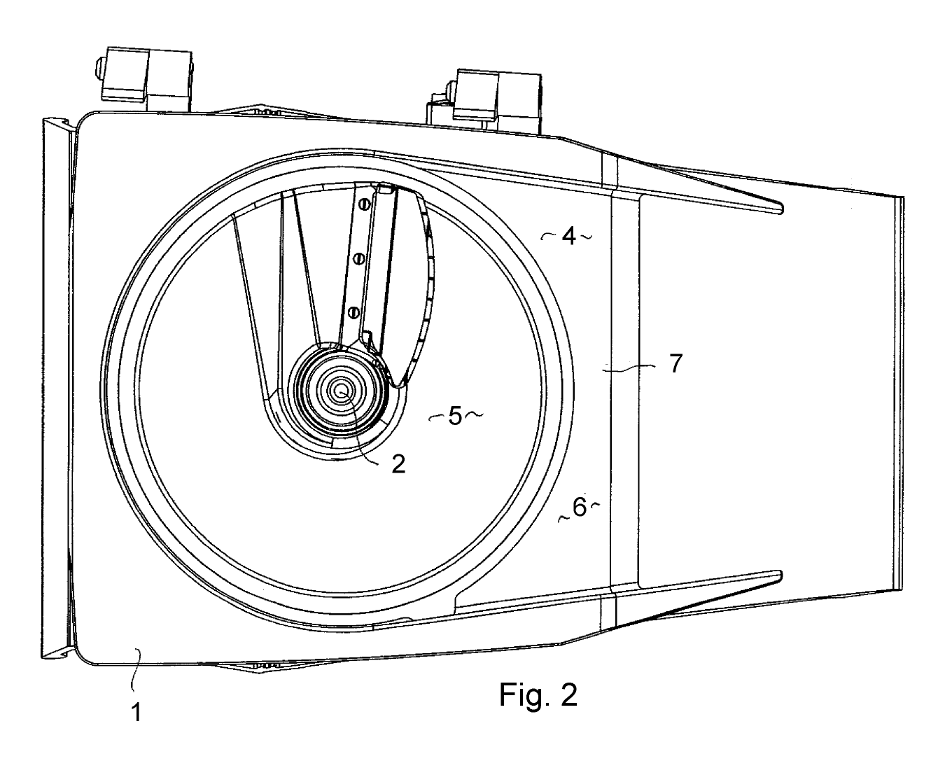

FIG. 2 shows a top view of the machine in FIG. 1

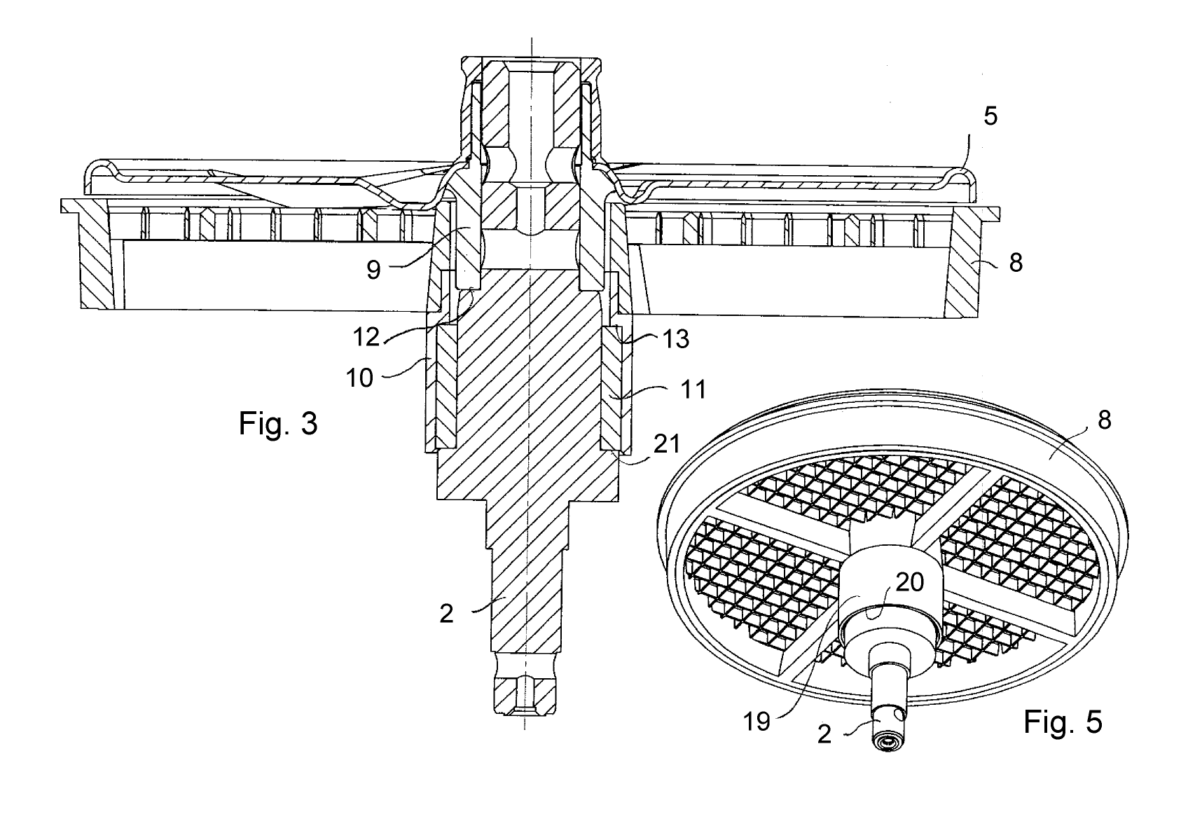

FIG. 3 shows a section view of the part of the machine according to FIG. 1 and according to a first embodiment

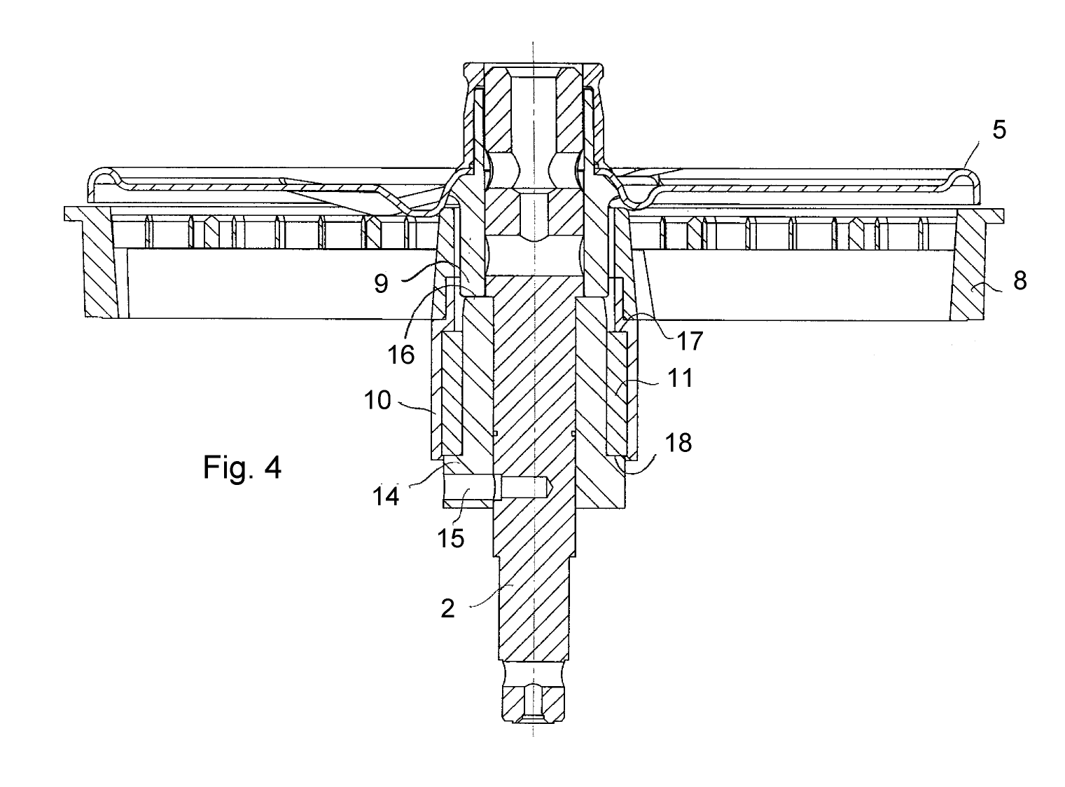

FIG. 4 shows a section view of a part of the machine according to FIG. 1 and according to a second embodiment

FIG. 5 shows a dicing grid.

In FIGS. 1 and 2, an upper part of a cutting machine for vegetables is shown. The cutting machine comprises a machine housing 1. In the upper part of the machine housing, cutting tools are arranged to be mounted around an axis 2 which is driven by a motor 3 arranged in the machine housing. The upper part of the machine housing 1 is shaped as a trough 4, running along the periphery of the cutting tool 5, which trough 4 has a bottom 6 out from which the said axis 2 protrudes upwards. The trough 4 is arranged to collect cut vegetables and is provided with a radially directed output channel 7 for cut vegetables.

According to the invention, there are provided two or more cooperating tool parts, where each tool part is supported directly or indirectly by one of two or several steps, arranged at a distance from each other and formed on one and the same machine element.

In FIG. 1, the tool parts are illustrated with a dicing grid 8 and a cutting disc 5 arranged on top of, but at a small distance from, the dicing grid 8.

In FIG. 5, a conventional dicing grid 8 is shown in a perspective view from below.

In FIGS. 3 and 4, among other things the dicing grid 8, the cutting disc 5 and the axis 2 are shown.

Above was mentioned that each tool part 5, 8 is supported directly or indirectly by one of two or several steps, arranged at a distance from each other and formed on one and the same machine element.

According to a first preferred embodiment, the machine element is the said axis 2. This embodiment is shown in FIG. 3. The reference number 9 denotes a cylindrical, central, tube-shaped part of the cutting disc 5. The reference numeral 10 denotes a central, tube-shaped part of the dicing grid 8. The reference number 11 denotes a bearing belonging to the dicing grid 8. During operation, the dicing grid is still while the cutting disc rotates.

In this embodiment, the tube-shaped part 9 of the cutting disc 5 rests against a first step 12, formed in the axis 2. The bearing 11 of the tube-shaped part 10 of the dicing grid 8 rests against a second step 21, formed in the axis 2. According to this embodiment, the two tool parts are thus supported directly on two steps which are arranged at a distance from each other. The first 12 and the second 21 steps have a mutual distance such that a desired distance is achieved between the two tool parts, the dicing grid and the cutting disc. Since the two steps are formed in one and the same machine element, that is the axis 2, the axis 2 can be machined so that the distance between the steps has a very high precision. Suitably, the axis 2 is made from a stainless steel. The lower part of the axis 2 is connected to an electric motor, not shown, in the machine housing.

By this embodiment, it is achieved that the precision in the distance between the dicing grid and the cutting disc is always high, even if the machine housing is made from stainless sheet metal which has been deformed due to heat induced tensions in the material.

In case the bearing 11 is not rotationally fixed to the dicing grid 8, hence the tube-shaped part 10 of the dicing grid 8 rests against the upper surface 13 of the bearing 11, where the bearing 11 in turn rests against the said second step 21, in other words the dicing grid is indirectly supported by the said second step 21. The bearing 11 may be a ball bearing.

The bearing may also be a loose sleeve which does not belong to the dicing grid 8.

According to a second preferred embodiment, the said machine element is a sleeve 14 surrounding the said axis 2, see figure 4. The sleeve 14 is fastened to the axis 2 using a jointing 15. According to this embodiment, the sleeve 14 comprises the said steps.

In this embodiment, the tube-shaped part 9 of the cutting disc 5 rests against a first step 16, comprised by the upper surface 16 of the sleeve 14. The tube-shaped part 10 of the dicing grid 8 rests against a second step 18 formed in the sleeve 14. These steps 16, 18 have a mutual distance such that a desired distance between the two tool parts, the dicing grid and the cutting disc, is achieved.

In case the bearing 11 is not rotationally fixed to the dicing grid 8, the tube-shaped part 10 of the dicing grid 8 thus rests on the upper surface 17 of the bearing 11, where the bearing 11 in turn rests on the said second step 18, in other words the dicing grid is indirectly supported by the said second step 18.

In both the first and the second preferred embodiments, the dicing grid is supported by the lower of said steps and the cutting disc by the upper of said steps.

According to a very preferred embodiment, the distance between the steps is such that the distance between the dicing grid and the part of the cutting disc located closest to the dicing grid is 0.1-0.4 millimeters.

According to a preferred embodiment, the said bearing 11 is a ceramic sleeve 20, located inside the tube-shaped part 19 of the dicing grid.

According to an alternative embodiment, the said bearing 11 is coated with a ceramic layer, so that at least the surface of the bearing which is arranged to abut against the lower one 18, 21 of the said steps is coated with a ceramic layer.

Above, a number of exemplifying embodiments have been described. However, it is apparent that the invention can be varied as regards the detailed design of the various elements.

Therefore, the present invention is not to be considered limited to the above described embodiments, but may be varied within the scope of the enclosed claims.

1. Device for mutually positioning tools in a cutting machine for vegetables, which cutting machine comprises a machine housing (1), wherein in the upper part of the machine housing cutting tools (5) are arranged to be mounted around an axis (2) which is driven by a motor (3) arranged in the machine housing, wherein the upper part of the machine housing is shaped as a trough (4), running along the periphery of the cutting tool (5), which trough (4) has a bottom (6) out from which the said axis (2) protrudes upwards and which trough is arranged to collect cut vegetables and which trough is provided with a radially directed output channel (7) for cut vegetables, characterised in that two or more cooperating tool parts (5,8) are provided, in that each tool part is supported directly or indirectly by one of two or several steps (16,18;12,21), arranged at a distance from each other and formed on one and the same machine element (2;14).

2. Device according to claim 1, characterised in that the machine element (2) is the said axis.

3. Device according to claim 1, characterised in that the machine element is a sleeve (14) surrounding the said axis (2).

4. Device according to claim 1, characterised in that a dicing grid (8) is supported on a lower one of said steps (18;21), and in that a cutting disc is supported on an upper one of said steps (12;16).

5. Device according to claim 4, characterised in that the distance between the steps (16,18;12,21) is such that the distance between the dicing grid (8) and the part of the cutting disc (5) located closest to the dicing grid is 0.1-0.4 millimeters.

6. Device according to claim 3 characterised in that the said sleeve (14) is supported on a bearing (11) on said axis (2), and in that a dicing grid (8) is supported on said bearing (11).

7. Device according to claim 6 characterised in that the said bearing (11) is a ceramic sleeve (20).

8. Device according to claim 6 characterised in that the said bearing (11) is coated with a ceramic layer so that at least the surface of the bearing which is arranged to abut against the lower one (18, 21) of said steps is coated with said ceramic material.

9. Device according to claim 2, wherein a dicing grid is supported on a lower one of said steps, and a cutting disc is supported on an upper one of said steps.

10. Device according to claim 4, wherein the sleeve is supported on a bearing (11) on said axis (2), and the dicing grid (8) is supported on said bearing (11).
